(19) United States
(12) Patent Application Publication
(10) Pub. No.: US 2026/0204709 A1
(43) Pub. Date: Jul. 16, 2026

(54) SECONDARY BATTERY

(71) Applicant: TOYOTA JIDOSHA KABUSHIKI KAISHA, Toyota-shi (JP)

(72) Inventor: Ippei GOTO, Okazaki-shi (JP)

(73) Assignee: TOYOTA JIDOSHA KABUSHIKI KAISHA, Toyota-shi (JP)

(21) Appl. No.: 19/321,796

(22) Filed: Sep. 8, 2025

(30) Foreign Application Priority Data
Jan. 15, 2025 (JP) 2025-005473

(51) Int. Cl. H01M 50/242; H01M 10/0562; H01M 10/0585; H01M 50/517

(52) U.S. Cl. CPC H01M 50/242; H01M 10/0562; H01M 10/0585; H01M 50/517; H01M 2300/0068

(57) ABSTRACT

A secondary battery includes a plurality of laminated bodies. Each of the laminated bodies includes a first current collector, a first electrode layer disposed on one main surface of the first current collector, a second current collector, a second electrode layer disposed on one main surface of the second current collector, and an electrolyte layer disposed between the first electrode layer and the second electrode layer. A pair of adjacent laminated bodies among the laminated bodies is bonded to each other via the first current collectors or via the second current collectors. The bonding strength between the first current collectors is weaker than that between the first current collector and the first electrode layer, and the bonding strength between the second current collectors is weaker than that between the second current collector and the second electrode layer.

### CROSS-REFERENCE TO RELATED APPLICATION

This application claims priority to Japanese Patent Application No. 2025-005473 filed on January 15, 2025. The disclosure of the above-identified application, including the specification, drawings, and claims, is incorporated by reference herein in its entirety.

### BACKGROUND

### 1. Technical Field

The present disclosure relates to secondary batteries.

### 2. Description of Related Art

Some secondary batteries, such as solid-state batteries using solid electrolytes, are configured such that a battery unit is housed in an exterior case. The battery unit is a stack of a plurality of laminated bodies each including a cathode current collector and an anode current collector. Specifically, Japanese Unexamined Patent Application Publication No. 2017-204377 (JP 2017-204377 A) specifically discloses a solid-state battery in which a plurality of laminated bodies, each including a cathode current collector, a cathode active material layer, a solid electrolyte layer, an anode active material layer, and an anode current collector, are stacked. In the solid-state battery disclosed in JP 2017-204377 A, the laminated bodies are bonded to each other using a thermoplastic resin such as an ethylene-vinyl acetate copolymer. More specifically, according to JP 2017-204377 A, in the case where the current collector located on the outermost layer of the laminated body has a rectangular shape, a thermoplastic resin is applied in an L-shape along each corner of the rectangular shape to bond the laminated bodies to each other.

### SUMMARY

In secondary batteries such as solid-state batteries, repeated charging and discharging cause expansion and contraction of components such as the cathode active material and the anode active material. Repeated expansion and contraction of components such as the cathode active material and the anode active material may result in the accumulation of stress within the laminated body including the cathode current collector, the cathode active material layer, the solid electrolyte layer, the anode active material layer, and the anode current collector, potentially leading to damage. Accordingly, an object of one embodiment of the present disclosure is to provide a secondary battery capable of alleviating stress generated within a laminated body.

The present disclosure, which has achieved the above object, encompasses the following aspects.

(1) A secondary battery including a plurality of laminated bodies stacked in a stacking direction, each of the laminated bodies including a first current collector, a first electrode layer disposed on one main surface of the first current collector, a second current collector, a second electrode layer disposed on one main surface of the second current collector, and an electrolyte layer disposed between the first electrode layer and the second electrode layer, wherein: a pair of adjacent laminated bodies among the laminated bodies is bonded to each other via the first current collectors or via the second current collectors; and the bonding strength between the first current collectors is weaker than the bonding strength between the first current collector and the first electrode layer, and the bonding strength between the second current collectors is weaker than the bonding strength between the second current collector and the second electrode layer.

(2) The secondary battery according to (1), wherein either or both of the first electrode layer and the second electrode layer contain a material configured to expand and contract during charging and discharging.

(3) The secondary battery according to (1) or (2), wherein either or both of the interface between the first current collector and the first electrode layer and the interface between the second current collector and the second electrode layer are bonded via an electrically conductive adhesive layer.

(4) The secondary battery according to any one of (1) to (3), wherein: each of the laminated bodies has a structure in which the second electrode layer is disposed on each of both main surfaces of the second current collector, and the electrolyte layer, the first electrode layer, and the first current collector are disposed in this order on each of the second electrode layers; and the pair of adjacent laminated bodies among the laminated bodies is bonded to each other via the first current collectors.

(5) The secondary battery according to any one of (1) to (4), wherein the electrolyte layer contains a solid electrolyte.

In the secondary battery according to the embodiment of the present disclosure, even when components constituting the electrodes (particularly active materials) repeatedly undergo expansion and contraction due to charging and discharging, stress can be alleviated between adjacent laminated bodies, thereby reducing the possibility of damage resulting from stress accumulation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a main part of a secondary battery according to an embodiment of the present disclosure;

FIG. 2 is a cross-sectional view of a main part of a secondary battery according to another embodiment of the present disclosure; and

FIG. 3 is a cross-sectional view of a main part of a secondary battery according to still another embodiment of the present disclosure.

### DETAILED DESCRIPTION OF EMBODIMENTS

Hereinafter, embodiments of the present disclosure will be described with reference to the drawings. However, the configurations of the embodiments are not limited to those illustrated in the drawings. The sizes of the components shown in the drawings are conceptual, and the relative sizes between the components are not limited thereto.

### Secondary Battery

The secondary battery of the present disclosure includes a plurality of laminated bodies stacked in a stacking direction. Each of the laminated bodies includes a first current collector, a first electrode layer disposed on one main surface of the first current collector, a second current collector, a second electrode layer disposed on one main surface of the second current collector, and an electrolyte layer disposed between the first electrode layer and the second electrode layer. In the secondary battery of the present disclosure, a pair of adjacent laminated bodies among the laminated bodies is bonded to each other via the first current collectors or via the second current collectors. In the secondary battery of the present disclosure, the bonding strength between the first current collectors is weaker than the bonding strength between the first current collector and the first electrode layer, and the bonding strength between the second current collectors is weaker than the bonding strength between the second current collector and the second electrode layer. In the secondary battery of the present disclosure, the laminated bodies can be bonded by a resin. In one embodiment of the secondary battery of the present disclosure, when the laminated bodies are bonded by a resin, the resin layer provided between adjacent laminated bodies is referred to as a weak bonding layer. That is, in one embodiment of the secondary battery of the present disclosure, the bonding strength between the laminated bodies via the weak bonding layer is weaker than the bonding strength between the first current collector and the first electrode layer within each laminated body and the bonding strength between the second current collector and the second electrode layer within each laminated body.

The first current collector and the first electrode layer, and the second current collector and the second electrode layer, each constitute either the cathode or the anode (i.e., they are opposed electrodes). Specifically, when the first current collector and the first electrode layer constitute the cathode, the second current collector and the second electrode layer constitute the anode. Conversely, when the first current collector and the first electrode layer constitute the anode, the second current collector and the second electrode layer constitute the cathode. In the present disclosure, the first and second current collectors may be collectively referred to as "current collectors," and the first and second electrode layers may be collectively referred to as "electrode layers."

In the secondary battery of the present disclosure, even when active materials or the like contained in the first electrode layer and the second electrode layer repeatedly undergo expansion and contraction due to charging and discharging, stress can be alleviated between adjacent laminated bodies, thereby reducing the possibility of damage resulting from stress accumulation. In the secondary battery of the present disclosure, the bonding strength between adjacent laminated bodies is weaker than the bonding strength between the current collector and the electrode layer within each laminated body, whereby stress can be alleviated between the adjacent laminated bodies. The bonding strength between adjacent laminated bodies and the bonding strength between the current collector and the electrode layer can be compared based on the tensile strength measured by a tensile test. For example, the tensile strength between adjacent laminated bodies is preferably at least 5% lower than the tensile strength between the current collector and the electrode layer, more preferably at least 10% lower, and even more preferably at least 20% lower.

Therefore, in the secondary battery of the present disclosure, either or both of the first electrode layer and the second electrode layer may contain a material configured to expand and contract during charging and discharging. That is, in the secondary battery of the present disclosure, even when either or both of the cathode and the anode contain a material configured to expand and contract during charging and discharging, stress can be alleviated between adjacent laminated bodies.

In the secondary battery of the present disclosure, the current collector and the electrode layer may be directly joined together. For example, the current collector and the electrode layer can be directly joined by forming the electrode layer on a main surface of the current collector. Alternatively, in the secondary battery of the present disclosure, the current collector and the electrode layer may be joined via an electrically conductive adhesive layer. For example, the current collector and the electrode layer can be joined via an electrically conductive adhesive layer by forming an electrically conductive adhesive layer on a main surface of the current collector and laminating an electrode layer separately formed on a substrate onto the electrically conductive adhesive layer formed on the main surface of the current collector. For example, either or both of the interface between the first current collector and the first electrode layer and the interface between the second current collector and the second electrode layer may be bonded via an electrically conductive adhesive layer. In the secondary battery disclosed herein, when an electrically conductive adhesive layer is present between the current collector and the electrode layer, the bonding strength of the weak bonding layer between adjacent laminated bodies is weaker than the bonding strength of the electrically conductive adhesive layer included in each laminated body. The bonding strength of the weak bonding layer and the bonding strength of the electrically conductive adhesive layer can also be compared based on the tensile strength measured by a tensile test, as described above.

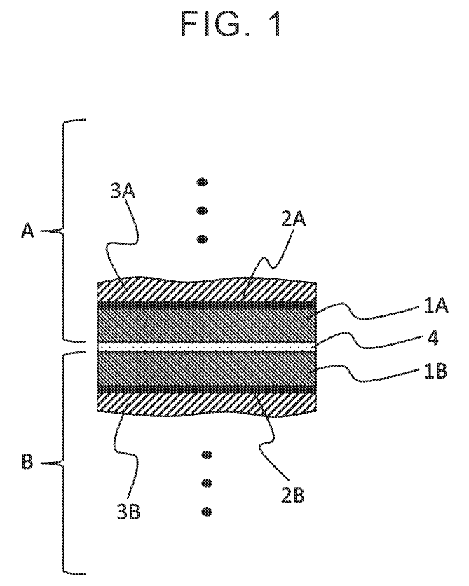

An embodiment of the secondary battery according to the present disclosure is shown in FIG. 1. FIG. 1 illustrates a joint portion between a pair of adjacent laminated bodies A, B in the secondary battery of the present disclosure. FIG. 1 shows only the main parts of the laminated bodies A, B. In the secondary battery of the present disclosure, the laminated body A has a structure in which a current collector 1A, an electrically conductive adhesive layer 2A, and an electrode layer 3A are laminated in this order. The laminated body B has a structure in which a current collector 1B, an electrically conductive adhesive layer 2B, and an electrode layer 3B are laminated in this order. In the secondary battery of the present disclosure, the current collector 1A of the laminated body A and the current collector 1B of the laminated body B are joined to each other via a weak bonding layer 4. In the secondary battery of the present disclosure shown in FIG. 1, the bonding strength between the current collector 1A and the current collector 1B is weaker than the bonding strength between the current collector 1A and the electrode layer 3A and the bonding strength between the current collector 1B and the electrode layer 3B. In other words, the bonding strength of the weak bonding layer 4 interposed between the current collectors 1A, 1B is weaker than the bonding strength of the electrically conductive adhesive layer 2A and the bonding strength of the electrically conductive adhesive layer 2B. In the secondary battery of the present disclosure shown in FIG. 1, stress generated in the laminated bodies A, B, etc. can be alleviated by the weak bonding layer 4.

The weak bonding layer 4 can alleviate stress generated by repeated expansion and contraction of the active material contained in the electrode layer due to charging and discharging. However, the stress that can be alleviated by the weak bonding layer 4 is not limited to this. The weak bonding layer 4 can also alleviate stress generated by, for example, vibration applied to the secondary battery. Accordingly, the secondary battery of the present disclosure having the structure shown in FIG. 1 can reduce the possibility of delamination between layers within each of the laminated bodies A, B, and of cracking occurring in the laminated bodies A, B.

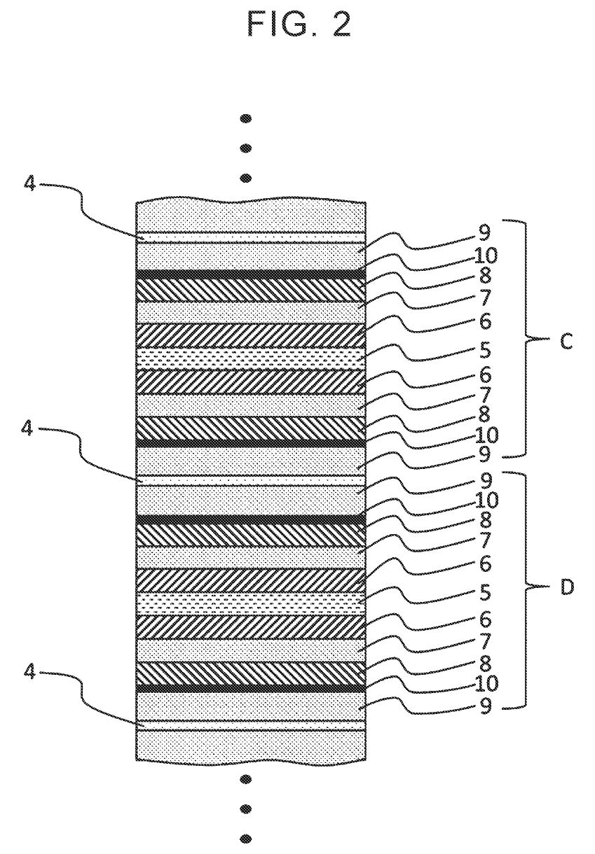

Another embodiment of the secondary battery according to the present disclosure is shown in FIG. 2. FIG. 2 illustrates an example in which the secondary battery has a structure in which second electrode layers are disposed on both main surfaces of a second current collector, and on each of these second electrode layers, an electrolyte layer, a first electrode layer, and a first current collector are disposed in this order. A pair of adjacent laminated bodies among a plurality of laminated bodies is bonded to each other via their respective first current collectors. In the embodiment shown in FIG. 2, the first current collector and the first electrode layer correspond to a cathode current collector and a cathode layer, respectively, and the second current collector and the second electrode layer correspond to an anode current collector and an anode layer, respectively.

The secondary battery shown in FIG. 2 has a structure in which a laminated body C and a laminated body D are joined to each other via a weak bonding layer 4. The laminated bodies C, D have the same layer structure, with an anode current collector 5 disposed at the center in the stacking direction. The laminated bodies C, D have a structure in which anode layers 6 are disposed on both main surfaces of the anode current collector 5, and on each of these anode layers 6, a solid electrolyte layer 7, a cathode layer 8, and a cathode current collector 9 are disposed in this order. In the laminated bodies C, D, the cathode layer 8 and the cathode current collector 9 are joined together by an electrically conductive adhesive layer 10.

In the secondary battery in FIG. 2 configured as described above, the cathode current collector 9 of the laminated body C and the cathode current collector 9 of the laminated body D are joined to each other via a weak bonding layer 4. In each of laminated bodies C, D, the cathode current collector 9 is joined to the cathode layer 8 via an electrically conductive adhesive layer 10. In this secondary battery as well, the bonding strength of the weak bonding layer 4 between the cathode current collectors 9 is weaker than the bonding strength of the electrically conductive adhesive layer 10. Accordingly, in the secondary battery of the present disclosure shown in FIG. 2 as well, even when stress is generated in the laminated bodies C, D etc. due to repeated expansion and contraction of the active materials contained in the cathode layers 8 and the anode layers 6 as a result of charging and discharging, the generated stress can be alleviated by the weak bonding layer 4. In addition, in this secondary battery as well, stress caused by, for example, vibration applied to the secondary battery can also be alleviated. Accordingly, the secondary battery of the present disclosure having the structure shown in FIG. 2 can reduce the possibility of delamination between layers within each of the laminated bodies C, D, and of cracking occurring in the laminated bodies C, D.

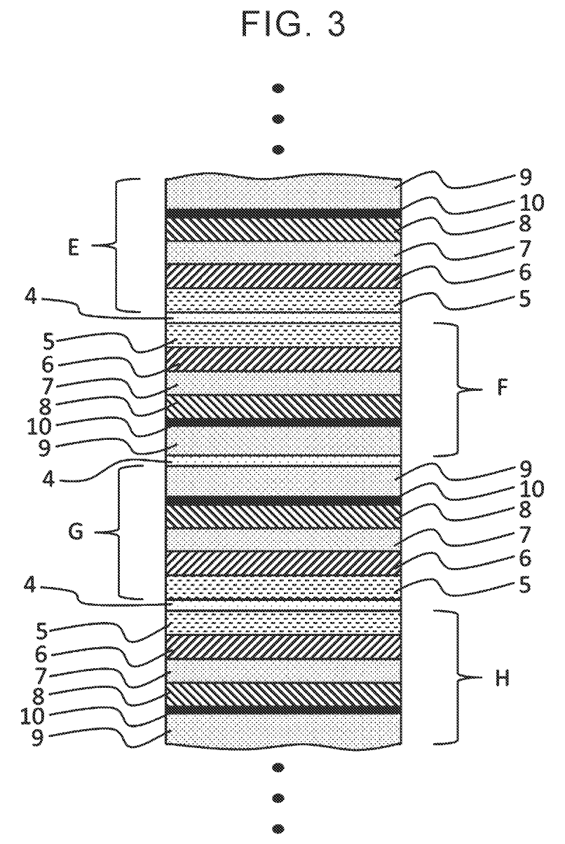

Still another embodiment of the secondary battery according to the present disclosure is shown in FIG. 3. The secondary battery shown in FIG. 3 has a structure in which laminated bodies E, F, G, H are joined in this order. Each of laminated bodies E, F, G, H includes: an anode current collector 5; an anode layer 6 disposed on one main surface of the anode current collector 5; a solid electrolyte layer 7 disposed on the anode layer 6; a cathode layer 8 disposed on the solid electrolyte layer 7; a cathode current collector 9 disposed on the cathode layer 8; and an electrically conductive adhesive layer 10 that bonds the cathode layer 8 and the cathode current collector 9. That is, the laminated bodies E, F, G, H all have the same layer structure. However, in the secondary battery shown in FIG. 3, the laminated bodies E, G and the laminated bodies F, H are arranged such that their stacking directions are opposite to each other. In the secondary battery shown in FIG. 3, the laminated bodies E, F are bonded to each other via their respective anode current collectors 5 through a weak bonding layer 4. In the secondary battery shown in FIG. 3, the laminated bodies F, G are bonded to each other via their respective cathode current collectors 9 through a weak bonding layer 4. In the secondary battery shown in FIG. 3, the laminated bodies G, H are bonded to each other via their respective anode current collectors 5 through a weak bonding layer 4.

In the secondary battery in FIG. 3 configured as described above, the cathode current collector 9 of the laminated body F and the cathode current collector 9 of the laminated body G are bonded to each other via the weak bonding layer 4. In each of the laminated bodies F, G, the cathode current collector 9 is bonded to the cathode layer 8 via the electrically conductive adhesive layer 10. In this secondary battery as well, the bonding strength of the weak bonding layer 4 interposed between the cathode current collectors 9 is weaker than the bonding strength of the electrically conductive adhesive layer 10. Accordingly, in the secondary battery of the present disclosure shown in FIG. 3 as well, even when stress is generated in the laminated bodies E, F, G, H etc. due to repeated expansion and contraction of the active materials contained in the cathode layer 8 and the anode layer 6 as a result of charging and discharging, the generated stress can be alleviated by the weak bonding layer 4. In addition, in this secondary battery as well, stress caused by, for example, vibration applied to the secondary battery can also be alleviated. Accordingly, the secondary battery of the present disclosure having the structure shown in FIG. 3 can reduce the possibility of delamination between layers within each of the laminated bodies E, F, G, H, and of cracking occurring in the laminated bodies E, F, G, H.

Moreover, in the secondary battery shown in FIG. 3, the anode current collector 5 of the laminated body E and the anode current collector 5 of the laminated body F are bonded to each other via the weak bonding layer 4, and the anode current collector 5 of the laminated body G and the anode current collector 5 of the laminated body H are bonded to each other via a weak bonding layer 4. In the secondary battery of the present disclosure, the bonding strength of the weak bonding layer 4 interposed between the anode current collectors 5 is weaker than the bonding strength between the anode current collector 5 and the anode layer 6. Accordingly, in the secondary battery of the present disclosure shown in FIG. 3, even when stress is generated in the laminated bodies E, F, G, H, etc. due to repeated expansion and contraction of the active materials contained in the cathode layer 8 and the anode layer 6 as a result of charging and discharging, the generated stress can be alleviated by the weak bonding layer 4 located between the anode current collectors 5. Accordingly, the secondary battery of the present disclosure having the structure shown in FIG. 3 can more reliably reduce the possibility of delamination between layers within each of the laminated bodies E, F, G, H, and of cracking occurring in the laminated bodies E, F, G, H.

### Components of Secondary Battery

### Weak Bonding Layer

The weak bonding layer is disposed between the laminated bodies described above, and serves to bond the laminated bodies to each other. The weak bonding layer contains a resin that contributes to bonding between the laminated bodies. The resin is not particularly limited and may be, for example, at least one selected from among butadiene rubber (BR)-based binders, butyl rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, polyimide (PI)-based binders, carboxymethyl cellulose (CMC)-based binders, polyacrylate-based binders, and polyacrylic ester-based binders. Among these, it is particularly preferable that the weak bonding layer contain a PVdF-based binder as a main component. The PVdF-based binder may be a copolymer containing units derived from monomers other than vinylidene fluoride (VdF). A single type of polymer may be used alone, or two or more types may be used in combination.

The weak bonding layer may also contain electrically conductive particles or non-electrically-conductive particles in addition to the resin mentioned above. The bonding strength of the weak bonding layer can be adjusted as appropriate by the content of the electrically conductive or non-electrically conductive particles in the weak bonding layer. The bonding strength of the weak bonding layer depends on the area of contact between the resin component contributing to the bonding strength and the laminated bodies. Therefore, when the weak bonding layer contains electrically conductive or non-electrically conductive particles, the bonding strength of the weak bonding layer can be reduced as the content of the electrically conductive or non-electrically conductive particles increases.

The electrically conductive particles used in the weak bonding layer are not particularly limited, but it is preferable to use a carbon material. Examples of the carbon material include graphite materials, amorphous carbon materials, carbon black, and activated carbon. Examples of graphite materials include natural graphite and artificial graphite. Examples of amorphous carbon materials include hard carbon, soft carbon, coke, mesocarbon microbeads (MCMBs), and mesophase pitch-based carbon fibers (MCFs). The non-electrically conductive particles used in the weak bonding layer are not particularly limited, but examples include inorganic materials such as silica (such as spherical silica and crystalline silica), glass, alumina, calcium carbonate, zirconium silicate, calcium silicate, silicon nitride, aluminum nitride, boron nitride, beryllia, zirconia, zircon, forsterite, steatite, spinel, mullite, titania, talc, clay, and mica.

The bonding strength of the weak bonding layer depends on the area of contact between the resin component contributing to the bonding strength and the laminated bodies. Therefore, even when the weak bonding layer does not contain electrically conductive particles or non-electrically conductive particles, the bonding strength between the laminated bodies via the weak bonding layer can be reduced by reducing the contact area of the weak bonding layer between the laminated bodies. For example, the bonding strength between the laminated bodies can be reduced by intermittently applying the weak bonding layer such that it is present in partial regions between the laminated bodies.

### Cathode Current Collector

The cathode current collector may be any commonly used cathode current collector for batteries. Examples of metals that may be used for the cathode current collector include copper (Cu), nickel (Ni), chromium (Cr), gold (Au), platinum (Pt), silver (Ag), aluminum (Al), iron (Fe), titanium (Ti), zinc (Zn), cobalt (Co), and stainless steel.

### Cathode Layer

The cathode layer contains at least a cathode active material, and may further optionally contain an electrolyte, an electrically conductive additive, a binder, and the like. The cathode layer may further contain various other additives. The cathode active material may be any known material used as a cathode active material for secondary batteries. Examples of the cathode active material include, for example, at least one selected from various lithium-containing compounds, elemental sulfur, sulfur compounds, and the like. A single type of cathode active material may be used alone, or two or more types may be used in combination.

### Solid Electrolyte

The solid electrolyte contained in the solid electrolyte layer preferably includes at least one type of solid electrolyte selected from the group consisting of sulfide solid electrolytes, oxide solid electrolytes, and halide solid electrolytes.

The sulfide solid electrolyte preferably contains sulfur (S) as the main anionic element, and preferably further contains, in addition to S, lithium (Li), an element A, and sulfur (S). The element A is at least one selected from the group consisting of phosphorus (P), arsenic (As), antimony (Sb), silicon (Si), germanium (Ge), tin (Sn), boron (B), aluminum (Al), gallium (Ga), and indium (In). The sulfide solid electrolyte may further contain oxygen (O), a halogen element, or both. Examples of halogen elements (X) include fluorine (F), chlorine (Cl), bromine (Br), and iodine (I). The oxide solid electrolyte preferably contains oxygen (O) as the main anionic element, and may include lithium (Li), and an element Q (where Q represents at least one selected from niobium (Nb), boron (B), aluminum (Al), silicon (Si), phosphorus (P), titanium (Ti), zirconium (Zr), molybdenum (Mo), tungsten (W), and sulfur (S)), and oxygen (O). Examples of oxide solid electrolytes include garnet-type solid electrolytes, perovskite-type solid electrolytes, NASICON-type solid electrolytes, Li–P–O solid electrolytes, and Li–B–O solid electrolytes. The halide solid electrolyte is suitably a solid electrolyte containing lithium (Li), an element M, and an element X (where M is at least one element selected from titanium (Ti), aluminum (Al), and yttrium (Y), and X is fluorine (F), chlorine (Cl), or bromine (Br)).

### Solid Electrolyte Layer

Examples of the solid electrolyte layer include electrolyte layers used in semi-solid-state batteries and all-solid-state batteries. The type of solid electrolyte contained in the solid electrolyte layer is not particularly limited. For example, a solid electrolyte selected from those mentioned above as usable in the electrode layers may be used. The solid electrolyte layer may be a single layer or may have a multilayer structure including two or more layers.

When the solid-state battery of the present disclosure includes a solid electrolyte, it may further include, along with the solid electrolyte, an electrolyte solution in an amount of less than 10 mass% relative to the total mass of the electrolyte. When the solid-state battery of the present disclosure includes a solid electrolyte, the solid electrolyte may be a composite solid electrolyte containing both an inorganic solid electrolyte and a polymer electrolyte. When the solid-state battery of the present disclosure includes an electrolytic solution as an electrolyte, the type of the electrolyte solution is not particularly limited, and any known electrolyte solution may be used. Specific examples of the electrolyte solution include liquids obtained by dissolving a lithium salt such as LiPF₆ or LiFSI in an organic solvent.

### Anode Layer

The anode layer contains at least an anode active material, and may further optionally contain an electrolyte, an electrically conductive additive, a binder, and the like. The anode layer may further contain various other additives. Examples of the anode active material include: carbon materials; active materials containing silicon (Si); metallic lithium; lithium-containing alloys; metals or alloys capable of forming alloys with lithium; oxides; and transition metal nitrides.

### Anode Current Collector

The anode current collector may be any commonly used anode current collector for batteries. Examples of metals that may be used for the anode current collector include copper (Cu), nickel (Ni), chromium (Cr), gold (Au), platinum (Pt), silver (Ag), aluminum (Al), iron (Fe), titanium (Ti), zinc (Zn), cobalt (Co), and stainless steel. The anode current collector may have a coating layer on its surface, for example, for the purpose of adjusting electrical resistance. The anode current collector may also be formed by plating or depositing, by vapor deposition, any of the above-mentioned metals onto a metal foil or a substrate. When the anode current collector is formed of a plurality of metal foils, it may further include a layer interposed between the metal foils.

### Electrically Conductive Adhesive Layer

The electrically conductive adhesive layer serves not only as an adhesive layer for bonding the cathode current collector and the cathode layer and bonding the anode current collector and the anode layer, as described above, but also as an electrically conductive layer that ensures electrical conduction between the cathode current collector and the cathode layer, and between the anode current collector and the anode layer. The resin and electrically conductive particles contained in the electrically conductive adhesive layer may be selected as appropriate from the materials described above for the weak bonding layer.

The secondary battery of the present disclosure will now be described with reference to an example. However, the technical scope of the present disclosure is not limited to the following example.

In the present example, an electrode assembly was fabricated for evaluation by bonding a different cathode current collector to the cathode current collector of a laminated body including a cathode current collector, a cathode layer, a solid electrolyte layer, an anode layer, and an anode current collector in this order, via a weak bonding layer. The interlayer bonding strength was evaluated by a tensile test.

### Preparation of Post-Attached Foil

In this example, in order to fabricate the laminated body described above, a cathode current collector having a weak bonding layer on its one main surface and an electrically conductive adhesive layer on the other main surface (in this example, this cathode current collector is referred to as "post-attached foil") was prepared. The post-attached foil was prepared as follows.

An electrically conductive paste was prepared by weighing 100 mass% of a polyvinylidene fluoride (PVdF) binder relative to 100 mass% of electrically conductive particles (carbon nanofibers, specific surface area: 14 m²/g), mixing these components in butyl butyrate to obtain a solids content of 50 mass%, and subjecting the mixture to ultrasonic dispersion for one minute using an ultrasonic disperser. The electrically conductive paste thus obtained was uniformly applied onto an aluminum foil having a thickness of 15 μm by blade coating using a commercially available applicator to achieve a coating weight of 1.0 mg/cm². The coated film was then dried at 100°C for 60 minutes to form an electrically conductive adhesive layer on the aluminum foil. Next, a weak adhesive paste was prepared by weighing 10 mass% of a PVdF binder relative to 100 mass% of silica particles (0.1 μm), mixing these components in butyl butyrate to obtain a solid content of 50 mass%, and subjecting the mixture to ultrasonic dispersion for one minute using an ultrasonic disperser. The weak adhesive paste thus obtained was uniformly applied onto the other main surface of the aluminum foil (having the electrically conductive adhesive layer on one main surface) by blade coating using a commercially available applicator to achieve a coating weight of 0.5 mg/cm². The coated film was then dried at 100°C for 60 minutes. A post-attached foil, that is, an aluminum foil having an electrically conductive adhesive layer on one main surface and a weak bonding layer on the other main surface, was prepared in this manner.

### Preparation of Solid Electrolyte Sheet

A glass ceramic having an average particle size (D50) of 1 μm and a composition of 15LiBr–10LiI–75(0.75Li₂S–0.25P₂S₅) was used as a sulfide solid electrolyte. A solid electrolyte paste was prepared by weighing 1 mass% of a PVdF binder (the same binder as that used for the post-applied foil) relative to 100 mass% of the sulfide solid electrolyte, mixing these components in butyl butyrate to obtain a solid content of 50 mass%, and subjecting the mixture to ultrasonic dispersion for one minute using an ultrasonic disperser. The solid electrolyte paste thus obtained was uniformly applied onto an aluminum foil having a thickness of 15 μm by blade coating using a commercially available applicator to achieve a coating weight of 3.0 mg/cm². The coated film was then dried at 100°C for 60 minutes to form a solid electrolyte layer on the aluminum foil. A solid electrolyte sheet was thus prepared.

### Preparation of Cathode Sheet

LiNi_{1/3}Mn_{1/3}Co_{1/3}O₂ powder having an average particle diameter (D50) of 10 μm and a specific surface area of 1 m²/g was used as a cathode active material. The surface of the cathode active material was coated with LiNbO₃ using a sol-gel method. The same sulfide solid electrolyte as that used in the solid electrolyte sheet was used as a solid electrolyte contained in the cathode layer. A cathode paste for the cathode layer was prepared by weighing 20 mass% of the sulfide solid electrolyte, 10 mass% of electrically conductive particles (carbon nanofibers) (the same particles as those used for the post-applied foil) and 1 mass% of a PVdF binder (the same binder as that used for the post-applied foil) relative to 100 mass% of the cathode active material, mixing these components in butyl butyrate to obtain a solid content of 60 mass%, and subjecting the mixture to ultrasonic dispersion for one minute using an ultrasonic disperser. The cathode paste thus obtained was uniformly applied onto a cathode current collector made of an aluminum foil with a thickness of 15 μm by blade coating using a commercially available applicator to achieve a coating weight of 33 mg/cm². The coated film was then dried at 100°C for 60 minutes to form a cathode layer on the cathode current collector. A cathode sheet was thus prepared.

### Preparation of Anode Sheet

Silicon (Si) powder having an average particle size (D50) of 3 μm and a specific surface area of 4 m²/g was used as an anode active material. The same sulfide solid electrolyte as that used in the solid electrolyte sheet was used as a solid electrolyte contained in the anode layer. An anode paste for the anode layer was prepared by weighing 50 mass% of the sulfide solid electrolyte, 10 mass% of electrically conductive particles (carbon nanofibers) (the same particles as those used for the post-applied foil), and 5 mass% of a PVdF binder (the same binder as that used for the post-applied foil) relative to 100 mass% of the anode active material, mixing these components in butyl butyrate to obtain a solid content of 40 mass%, and subjecting the mixture to ultrasonic dispersion for one minute using an ultrasonic disperser. The anode paste thus obtained was uniformly applied onto a surface-roughened copper foil having a thickness of 20 μm by blade coating using a commercially available applicator to achieve a coating weight of 7.5 mg/cm². The coated film was then dried at 100°C for 60 minutes. The surface-roughened copper foil was then turned over, and the same process was repeated, thereby producing the surface-roughened copper foil having anode layers on both surfaces. An anode sheet was thus prepared.

### Preparation of Electrode Assembly for Evaluation

Next, the anode sheet, the solid electrolyte sheet, and the cathode sheet were each cut into a square shape of 1.2 cm × 1.2 cm. The solid electrolyte layers of the solid electrolyte sheets were first respectively placed onto both surfaces of the anode sheet, and the resulting stack is subjected to roll pressing at a pressure of 1 ton/cm at room temperature to transfer the solid electrolyte layers onto the anode layers. Subsequently, the aluminum foils were peeled off from the solid electrolyte sheets, and the cathode layers of the cathode sheets were respectively placed onto the exposed solid electrolyte layers. The resulting stack was then subjected to roll pressing at a pressure of 2 tons/cm at room temperature to transfer the cathode layers onto the solid electrolyte layers. Densification was performed by roll pressing at 4 tons/cm at 150°C, and the aluminum foils were then peeled off from the cathode sheets to expose the cathode layers. In this manner, a laminated body was prepared in which an anode layer, a solid electrolyte layer, and a cathode layer were laminated in this order on both main surfaces of the anode current collector. Then, the post-attached foil was cut into a square shape of 1.2 cm × 1.2 cm, and the electrically conductive adhesive layers of the post-attached foils were respectively placed onto the cathode layers of the prepared laminated body. Aluminum foils were respectively placed on the weak bonding layers of the post-attached foils, and the resulting stack was subjected to roll pressing at 0.1 ton/cm at 180°C to join the electrically conductive adhesive layers of the post-attached foils to the cathode layers of the laminated body and to join the aluminum foils to the weak bonding layers of the post-attached foils. An electrode assembly for evaluation was thus prepared. The electrode assembly for evaluation thus obtained has a structure in which the cathode current collector is located at the bottom and the aluminum foil is located at the top. The aluminum foil at the top of the electrode assembly for evaluation is bonded to the aluminum foil of the post-attached foil via the weak bonding layer.

The electrode assembly for evaluation fabricated as described above was cut into a disk shape with a diameter of 11.28 mm using a hand punch. The top and bottom surfaces of the punched electrode assembly were fixed using a commercially available instant adhesive, and a tensile test was conducted. As a result, the electrode assembly for evaluation delaminated between the aluminum foils bonded via the weak bonding layer. The tensile strength was 20.4 N/cm². From these results, it was found that, by making the bonding strength between the laminated bodies weaker than the bonding strength between the current collector foil and the electrode layer within each laminated body, the possibility of displacement between adjacent laminated bodies can be reduced, and even when the active material undergoes expansion and contraction during charging and discharging, stress can be alleviated as delamination preferentially occurs between laminated bodies rather than within layers in each laminated body.

What is claimed is:

1. A secondary battery comprising a plurality of laminated bodies stacked in a stacking direction, each of the laminated bodies including a first current collector, a first electrode layer disposed on one main surface of the first current collector, a second current collector, a second electrode layer disposed on one main surface of the second current collector, and an electrolyte layer disposed between the first electrode layer and the second electrode layer, wherein:
a pair of adjacent laminated bodies among the laminated bodies is bonded to each other via the first current collectors or via the second current collectors; and
bonding strength between the first current collectors is weaker than bonding strength between the first current collector and the first electrode layer, and bonding strength between the second current collectors is weaker than bonding strength between the second current collector and the second electrode layer.

2. The secondary battery according to claim 1, wherein either or both of the first electrode layer and the second electrode layer contain a material configured to expand and contract during charging and discharging.

3. The secondary battery according to claim 1, wherein either or both of an interface between the first current collector and the first electrode layer and an interface between the second current collector and the second electrode layer are bonded via an electrically conductive adhesive layer.

4. The secondary battery according to claim 1, wherein:
each of the laminated bodies has a structure in which the second electrode layer is disposed on each of both main surfaces of the second current collector, and the electrolyte layer, the first electrode layer, and the first current collector are disposed in this order on each of the second electrode layers; and
the pair of adjacent laminated bodies among the laminated bodies is bonded to each other via the first current collectors.

5. The secondary battery according to claim 1, wherein the electrolyte layer contains a solid electrolyte.
